(19) United States
(12) Patent Application Publication
(10) Pub. No.: US 2008/0121848 A1
(43) Pub. Date: May 29, 2008

(54) Electrically conductive article

(76) Inventor: Douglas Nobbs, Dover, NH (US)

Correspondence Address: GOSZ AND PARTNERS LLP, ONE STATE STREET, BOSTON, MA, 02109, US

(21) Appl. No.: 11/729,534

(22) Filed: Mar. 29, 2007

Related U.S. Application Data
(60) Provisional application No. 60/788,197, filed on Mar. 31, 2006.

(51) Int. Cl. H01B 1/02; H01B 1/04; B29C 70/88

(52) U.S. Cl. 252/511; 252/500; 252/519.33; 252/512; 264/104

(57) ABSTRACT

The present invention relates to an electrically conductive article. The electrically conductive article is made of an injection moldable polymer. An electrically conductive material is embedded in the injection moldable polymer, and a carbon based material is also embedded in the injection moldable polymer. The electrically conductive article may be in the form of a pellet or a plate, and may be used as an EMI shield.

### CROSS-REFERENCE TO RELATED APPLICATIONS

This application claims the benefit of priority from U.S. Provisional Application No. 60/788,197 filed on Mar. 31, 2006, the specification of which is incorporated herein by reference.

### BACKGROUND OF THE INVENTION

Electromagnetic interference (EMI) is radiated or conducted energy that adversely affects circuit performance of an electronic circuit. Radiated EMI may be eliminated or reduced by the use of shielded enclosures and shielding materials.

Many types of electronic circuits radiate or are susceptible to EMI and must be shielded to ensure proper performance. In many electronic enclosures, it is desirable to seal or block openings in the chassis so that various electromagnetic noise and signals do not escape into the surrounding environment, and so that external signals do not enter the enclosure. For example, such electromagnetic noise can interfere with nearby television and radio equipment to the consternation of consumers.

In the past, this type of electromagnetic noise and associated signals have been controlled by designing enclosures which have openings that are much smaller than the wavelength of the electromagnetic noise involved.

Recently, attempts have been made to prepare conductive plastics by the addition of certain conductive fillers to the material. Specifically, these fillers include conductive powders, flakes and fibers. Generally, approximately 25-40% by weight of conductive powder, 36-49% by weight of conductive flake, or 25-30% by weight of conductive fiber must be present in order to obtain effective EMI shielding.

Additional pertinent disclosures are contained in U.S. Pat. Nos. 4,664,971; 4,559,262; 4,816,184; 4,973,514; 5,019,450; 5,137,766; 5,213,889; 5,366,664; 5,397,608 and WO 02/43456, the disclosures of which are incorporated by reference herein in their entireties.

While these and other developments have led to the provision of materials which exhibit improved EMS properties, there is a continuing need for improvement in the shielding properties of the materials. Also there is an increasing need to improve the cosmetic appearance by increasing the range of possible colors of the material.

One aspect of the present invention is to provide an electrically conductive article with better EMI shielding properties.

Another aspect of the present invention is to provide an electrically conductive article with an improved cosmetic appearance.

Yet another aspect of the present invention is to provide an electrically conductive article which may be produced in a wide range of possible colors.

### SUMMARY OF THE INVENTION

The present invention provides an electrically conductive article suitable for use as an EMI shield. The electrically article is made of an injection moldable polymer. An electrically conductive particulate material and a carbon based material are separately embedded into the injection moldable polymer to make pallets and these pallets are mechanically blended at an injection molding machine to produce an electrically conductive article. The combination of fillers provides for better EMI shielding effects.

### DETAILED DESCRIPTION OF THE INVENTION

In accordance with various embodiments of the present invention, an electrically conductive article suitable for use as an EMI shield is provided. The electrically conductive article is made of an injection moldable polymer. An electrically conductive particulate material and a carbon based material are separately embedded into the injection moldable polymer to make the injection moldable polymer conductive. The electrically conductive particulate material and the carbon based material act as fillers in the injection moldable polymer. The combination of two fillers provides for better EMI shielding properties.

In accordance with various embodiments of the present invention, the electrically conductive article formed from the present material may in the shape of pallets, plates and the like in order to be used as an EMI shield.

In accordance with various embodiments of the present invention, the injection moldable polymer may be thermosetting plastics, elastomers, thermoplastics or other polymers. By way of example, and not by way of limiting the scope of the invention, a non-exhaustive list of polymers that may be used in the present invention include olefine and polyolefin homopolymers, graft polymers and copolymers, for example polyethylene, polypropylene, polybutene, polyisobutylene, PVC, ethylene vinyl acetate polymers, fluorine-containing polymers, polyacetals, polystyrene, styrene copolymers, aromatic, aliphatic and mixed polyesters, polyamides and polyimides, polyethers, polycarbonates, polyurethanes, polyureas and other polymers obtainable by the polyisocyanate polyaddition process, acrylic ester/styrene copolymers, styrene-butadiene and styrene-butadiene-N-vinylpyridine copolymers, chlorobutadiene and polybutadiene (co)polymers, butadiene-acrylonitrile polymers, carboxylated styrene-butadiene copolymers, chloroprene (co)polymers, styrene-acrylonitrile polymers, polyacrylates, polyphenylene oxide, polysulphides, PPS, polysulphones, polyethane sulphones, cellulose esters, amino resins, phenolic resins, epoxy resins and alkyd resins of various compositions and the like.

The electrically conductive particulate material(s) may be embedded at levels from about 0 to about 50% by weight of the electrically conductive article. The electrically conductive particulate material can be amorphous or crystalline, solid, porous or hollow and have for example the shape of powders, balls, platelets, needles, dumb-bells, continuous fibers, chopped fibers etc.

In a preferred embodiment, the electrically conductive particulate material is a metal fiber. ‘Metal fiber’ may be defined as being metallically conducting fibers, wires and rods. The fibers can be present in the form of individual fibers, rovings, strands, yarns, threads, braids or ropes. By way of example, and not intending to limit the scope of the invention, a non-exhaustive list of metals that may be used include stainless steel, aluminium, gold, copper and alloys thereof with other metals, in which case the individual fibers may also be constructed layer by layer from different metals. It is also possible to use soft-magnetic metals, such as iron, nickel, cobalt and alloys thereof.

The metal fiber may also be formed from two or more metals, and formed for example by electrolytically applying a coat of metal on top of a core of another metal. Even combinations of metals and nonconductors are included.

It is similarly possible to use any desired combinations of fibers of different metals, or of metals and metallized fibers. The metals fibers can have identical or different diameters.

In accordance with various embodiments of the present invention the carbon based material is a carbon fiber. The carbon based material may be embedded in the article at levels of from about 0 to about 30% by weight of the electrically conductive article. The electrically conductive particulate material can be amorphous or crystalline, solid, porous or hollow, and have for example the shape of powders, balls, platelets, needles, dumb-bells, continuous fibers, chopped fibers etc.

The combination of electrically conductive particulate material and carbon based material provide a preferably synergistic effect in enhancing the electromagnetic shielding properties of the electrically conductive article at both high and low frequencies, and gives rise to a shield material of improved conductivity. It is theorized that the synergy is the combination of the “lossy” nature of carbon and the magnetic nature of the electrically conductive particulate matter.

The amount of these ingredients present in the electrically conductive article may vary depending on the particular application. In accordance with the most preferred embodiment of the invention, the electrically conductive particulate material is present in the electrically conductive article at a level of about 15% by weight (all percentages expressed as % by weight are based on the weight of the electrically conductive article), and the carbon based material is present at a level of about 15% by weight.

The electrically conductive article in accordance with the present invention may be prepared from an injection moldable polymer in the following manner. A first set of pallets is obtained by embedding an electrically conductive particulate material into the injection moldable polymer. A second set of pallets is obtained by embedding a carbon based material into the injection moldable polymer. The first set of pallets and the second set of pallets are blended in an injection molding machine to form the electrically conducting article.

In accordance with various embodiments of the present invention, the first set of pallets is obtained by a process selected from a set of processes including crosshead extrusion, single screw compounding and twin screw compounding.

In accordance with various embodiments of the present invention, the second set of pallets is obtained by a process selected from a set of processes including crosshead extrusion, single screw compounding and twin screw compounding.

The electrically conductive article of this invention has an unexpectedly high shielding effectiveness with respect to electromagnetic waves. With a given amount of electrically conductive material, the present invention yields remarkably improved shielding effectiveness compared to conventional techniques. The combination of electrically conductive particulate material and carbon based material allows for an improved cosmetic appearance over conventional techniques. The combination of electrically conductive particulate material and carbon based material also allows for a wider range of possible colors of the electrically conductive article.

The following example is provided to illustrate the invention but is not intended to limit the scope thereof in any way. All parts and percentages are by weight unless otherwise indicated.

### EXAMPLE 1

An electrically conductive article is prepared according to the following general procedure. For the purpose of this example, stainless steel fibers are used as the electrically conductive particulate material and carbon fibers are used as the carbon based material. Both fibers are separately compounded into an injection moldable polymer to form pallets, and these pallets are mechanically blended in an injection molding machine to produce a molded article with both fibers dispersed therein. The data below shows an unexpected synergistic effect with regards to the EMI shielding of these articles. The stainless steel fiber used was 5 mm long and 8 microns in diameter. The carbon fiber used was 6 mm long and 7 microns in diameter.

TABLE I

| Sample No. | Wt % SS Fiber | Wt % Carbon Fiber | dB EMI Shielding |
|---|---|---|---|
| 4435-132-22 | 0 | 30 | 35.8 |
| 4435-132-21 | 10 | 20 | 66.8 |
| 4435-132-20 | 15 | 15 | 67.8 |
| 4435-132-19 | 20 | 10 | 63.2 |
| 4435-132-23 | 30 | 0 | 60.6 |

As can be seen from the results shown in Table I, the samples with a blend of stainless steel and carbon fiber shows improved shielding properties compared to just carbon or just stainless steel filled polymers.

Stainless steel powders or flakes may be used instead of the stainless steel fibers and carbon flakes or powder may be used instead of the carbon fibers.

The injection moldable polymer may be any of the polymers that are typically used in molding, such as polyamides, polyethers, polycarbonates, polyolefins, polystyrene resins and vinyl resins, but the polymers are not limited to these.

The stainless steel fibers may also be replaced by any metal fibers such as copper fibers or fibers coated with metal or glass fibers plated with metal or coated with deposited metal. The length of the fibers is mostly the same as the length of the pellet, and is typically 2 to 15 mm, particularly 3 to 7 mm.

If powders are used in place of fibers, the stainless steel powder may be replaced metal powders such as copper, zinc and ferrite, and powders of mica or glass beads plated with metal or coated with deposited metal.

If flakes are used, the stainless steel flakes may be replaced by metal flakes such as aluminum flakes, copper flakes, zinc flakes and ferrite flakes.

The stainless steel fibers may also be replaced by a combination of continuous fibers and chopped fibers. The continuous fibers and chopped fibers may be composed of the same materials or of different materials. The length of the chopped fibers may be, for instance, from about 0.1 mm to 10 mm, preferably about 2 mm to about 6 mm.

A combination of two or more out of the aforesaid powders, flakes and chopped fibers may also be used in the invention.

It is preferred that the total weight of the electrically conductive particulate material and the carbon based material in the electrically conductive article amounts to 5% to 60% by weight of the total weight of the electrically conductive article.

If pellets are prepared by embedding relatively long fibers having the length of the pellet together with small powders, flakes or short fibers to substantially uniformly disperse relatively long fibers in the pellet, then many of the relatively long fibers will be chopped short by the shearing force during mixing, which results in deterioration of the shielding effectiveness. Of course, the relatively long fibers in the present invention are cut to a certain extent when the pellets are molded into the electrically conductive article. However, it is advantageous to avoid breaking the long fibers during the vigorous and prolonged embedding of the fibers in the pellets during the preparation of pellets.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is intended to cover all modifications, equivalents, and alternatives falling within the spirit and scope of the invention as defined by the following appended claims.

What is claimed is:

1. An electrically conductive article comprising:
an injection moldable polymer;
an electrically conductive particulate material, the electrically conductive particulate material being embedded in the injection moldable polymer, and
a carbon based particulate material, the carbon based particulate material being embedded in the injection moldable polymer.

2. The electrically conductive article of claim 1, wherein the electrically conductive article is an EMI shield.

3. The electrically conductive article of claim 1, wherein the electrically conductive article is in the form of a pallet.

4. The electrically conductive article of claim 1, wherein the electrically conductive article is in the form of a plate.

5. The electrically conductive article of claim 1, wherein the electrically conductive particulate material is stainless steel.

6. The electrically conductive article of claim 1, wherein the carbon based particulate material is carbon fiber.

7. The electrically conductive article of claim 1, wherein the electrically conductive particulate material is in a form selected from the group consisting of powders, flakes, continuous fibers, chopped fibers and mixtures thereof.

8. The electrically conductive article of claim 1, wherein the carbon based material is in a form selected from the group consisting of powders, flakes, continuous fibers, chopped fibers and mixtures thereof.

9. The electrically conductive article of claim 1, wherein the weight percent of the electrically conductive particulate material is in the range of 0% to 50% of the electrically conductive article.

10. The electrically conductive article of claim 1, wherein the weight percent of the carbon based material is in the range of 0% to 30% of the electrically conductive article.

11. The electrically conductive article of claim 1, wherein the electrically conductive particulate material is selected from the group consisting of metal fibers, metal plated fibers, metal powders and metal plated powders.

12. A method of making an electrically conductive article from an injection moldable polymer, the method comprising:
obtaining a first set of pallets by embedding an electrically conductive particulate material in the injection moldable polymer;
obtaining a second set of pallets by embedding a carbon based particulate material into the injection moldable polymer; and
blending the first set of pallets with the second set of pallets in an injection molding machine.

13. The method of claim 12, wherein the step of obtaining a first set of pallets is accomplished by a process selected form the group consisting of crosshead extrusion, single screw compounding and twin screw compounding.

14. The method of claim 12, wherein the step of obtaining a second set of pallets is accomplished by a process selected form the group consisting of crosshead extrusion, single screw compounding and twin screw compounding.
